(19) United States
(12) Patent Application Publication
(10) Pub. No.: US 2017/0288602 A1
(43) Pub. Date: Oct. 5, 2017

(54) Roof Attachment Flashing Assembly

(71) Applicant: Ironridge, Inc., Hayward, CA (US)

(72) Inventors: Shawn Meine, Phoenix, AZ (US); Jon Ash, Phoenix, AZ (US); Bryan Lester, Phoenix, AZ (US); David Taggart, San Carlos, CA (US)

(73) Assignee: IronRidge, Inc., Hayward, CA (US)

(21) Appl. No.: 15/630,878

(22) Filed: Jun. 22, 2017

Related U.S. Application Data
(62) Division of application No. 14/934,149, filed on Nov. 6, 2015.

(51) Int. Cl. H02S 20/23

(52) U.S. Cl. CPC H02S 20/23

(57) ABSTRACT

The present invention relates to a novel and improved roof flashing assembly for use in supporting hardware needed to install solar panel arrays on shingle roofs. The assembly is both easy to install and provides an improved watertight seal at the location where the assembly is secured to the rafters of the roof over the state of the art.

### BACKGROUND OF INVENTION

The present invention relates generally to a novel and improved roof flashing assembly that is both easy to install and provides a watertight seal to a composition shingle roof structure. One exemplary application of the flashing assembly is to connect it to hardware used to support guide rails that in turn support solar panel arrays installed on these roof structures. More specifically, the invention relates to a flashing assembly that provides improved and stronger watertight seals over the existing prior art flashing assemblies that also provide stronger support for heavy loads from the solar panel array elements that rest on the flashing assemblies.

Existing prior art flashing assembly designs are either unsatisfying in providing an adequate seal to prevent water from seeping into holes created while securing the flashing to the roof, are too complicated to install, or require too many individual parts making them more expensive to manufacture. In most traditional roof flashings, the bottom surfaces of the flashings must be pre-treated with a liberal amount of sealant before installing them to provide an effective watertight seal to the roof. Having to pre-treat a flashing is time consuming and may cause the flashing to be inconsistently sealed to the roof and cause leaking. Eliminating the need to pre-treat the flashing would be desirable.

In some prior art designs, the flashing includes an elevated block that rests above the flashing to seal out water. But at best, the location of the block may only possibly prevent water from entering at the top of the block. This is not ideal as it only addresses potential water leaks at the point where the top of the fastening element secures the flashing to the roof, which is above the flashing and not on the surface of the flashing where leaks are most likely to occur.

Another prior art design shown in U.S. Pat. Nos. 8,151,522; 8,153,700; 8,166,713; 8,146,299; 8,209,914; 8,245,454; 8,272,174; and 8,225,557 shows a flashing that utilizes an hourglass-shaped rubber seal that sits between an L-shaped bracket and the flashing. But this design does not have a compressive seal between both the flashing and the roof surface, which is included in the present invention. This design, which utilizes a raised mounting surface on the flashing, requires a bearing plate that is also unnecessary in the present invention. The flashing also requires a specific bracket attachment with a hollowed-out shape that conforms to the unique shape of the raised mounting surface on the flashing, and is unnecessary in the present design.

In another prior art design shown in U.S. Pat. No. 8,549,793, the disclosure teaches a flashing design that does not include a raised mounting surface on the flashing for providing support for mounting attachments. In particular, this design requires multiple seals both above and below the flashing to prevent penetration of liquids into the roof structure that are unnecessary in the present invention. The design also requires that a counter bore be done to remove a portion of the shingle in order to fit seal 6, which is unnecessary in the present design.

Finally, U.S. Pat. No. 8,756,881 discloses a solar panel attachment system that includes a flashing with a raised portion and a seal that rests on the top surface of the flashing and is compressed when the fastener is screwed into the rafter of the roof. But this system does not offer a solution that provides a seal between the flashing surface and the roof surface that may also be included in combination with a disk that is used to support the raised portion of the flashing and prevent it from collapsing due to heavy loads like the present invention.

Thus, a more simplistic flashing assembly that provides the ability to seal potential leaks at the fastener insertion point on shingle roofs and support solar panel arrays that is both easy to use and manufacture is desired.

### SUMMARY OF THE INVENTION

The invention is summarized below only for purposes of introducing embodiments of the invention. The ultimate scope of the invention is to be limited only to the claims that follow the specification.

It is an object of this invention to provide a novel and improved roof flashing assembly that provides a watertight seal between the flashing and roof that is both easy to manufacture and install.

It is an object of this invention that the roof flashing assembly be utilized to seal composition shingle roof structures.

It is an object of this invention to provide a roof flashing assembly that prevents external liquids from entering the roof structure where the flashing is secured to the roof without using additional liquid sealants on the lower surface of the flashing.

It is an object of this invention to provide a flashing assembly with a rubber seal in combination with a disk below the raised portion that prevents external liquids from entering the roof structure where the flashing is fastened to the roof.

It is an object of this invention to provide a flashing assembly such that the disk provides support to the raised portion by distributing any load that is secured to the top of the raised portion of the flashing and prevents it from collapsing downward.

It is an object of this invention to provide a flashing assembly with a flashing having a raised portion with an alternate geometry that provides load distribution while using a rubber seal beneath it to prevent external liquids from entering the roof structure where the flashing is fastened to the roof.

It is an object of this invention to provide a flashing assembly wherein the alternate geometry redirects liquids on the upper surface of the flashing away from the fastener insertion point on the roof.

A person with ordinary skill in the relevant art would know that any materials suitable to achieve the objects of the current invention may be chosen.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 illustrates a profile view of the elements used to assemble an embodiment of the flashing assembly.

FIG. 2 illustrates an exploded view of the flashing assembly constructed from the elements in FIG. 1.

FIG. 3A illustrates a front view the flashing assembly constructed from the elements in FIG. 1.

FIG. 3B illustrates a side view of the flashing assembly constructed from the elements in FIG. 1.

FIG. 4 illustrates a side view of the disk with the bushing inserted in the opening of the disk constructed from the elements in FIG. 1.

FIG. 5 illustrates a perspective view of a completed flashing assembly constructed from the elements in FIG. 1 that is secured to a solar panel mounting rail.

FIG. 6 illustrates a profile view of the elements used to assemble an alternate embodiment of the flashing assembly that utilizes no disk element and a modified flashing.

FIG. 7 illustrates an exploded view of the flashing assembly constructed from the elements in FIG. 6.

FIG. 8A illustrates a front view the flashing assembly constructed from the elements in FIG. 6.

FIG. 8B illustrates a side view of the flashing assembly constructed from the elements in FIG. 6.

FIG. 9 illustrates a perspective view of a completed flashing assembly constructed from the elements in FIG. 6.

FIG. 10 illustrates a profile view of the elements used to assemble an alternate embodiment of the flashing assembly that utilizes no disk element and a modified flashing.

FIG. 11 illustrates an exploded view of the flashing assembly constructed from the elements in FIG. 10.

FIG. 12A illustrates a front view the flashing assembly constructed from the elements in FIG. 10.

FIG. 12B illustrates a side view of the flashing assembly constructed from the elements in FIG. 10.

FIG. 13 illustrates a perspective view of a completed flashing assembly constructed from the elements in FIG. 10.

### DETAILED DESCRIPTION OF EXEMPLARY EMBODIMENTS

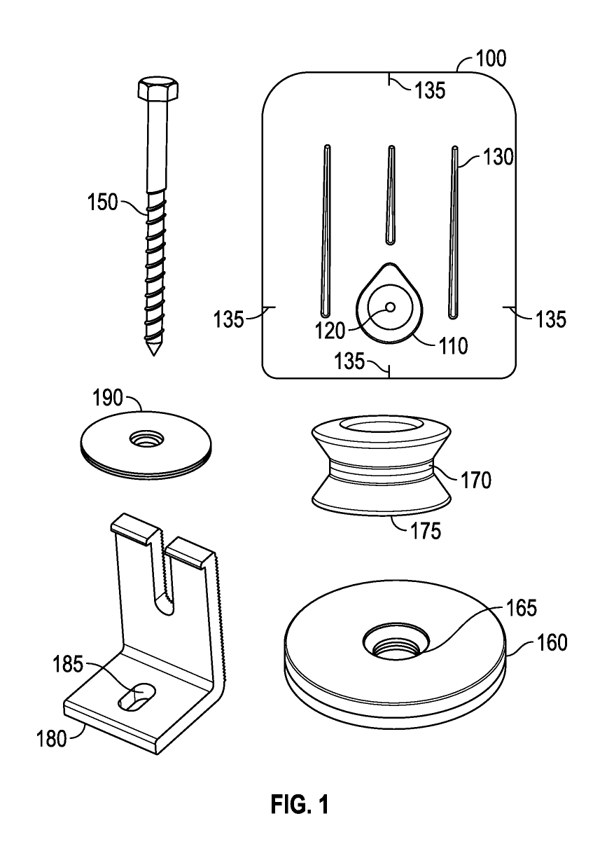

FIG. 1 illustrates an embodiment of the flashing assembly that is used to secure solar panel mounting rails in a solar panel array on a typical composition shingle roof. The flashing assembly includes a flashing 100. The flashing 100 is generally flat and rectangular, although alternate dimensions can be used as well. The flashing 100 includes a raised portion 110, which is completely hollow inside, and an opening 120 preferably located in the center of the raised portion 110 for use in receiving a fastener 150. The flashing 100 also may include ribs 130, and alignment markings 135 on the upper surface of the flashing 100 that enable accurate installation and location of the flashing 100 on the roof. The fastener 150 shown is a wood screw that is capable of penetrating shingle roofs and securing itself to the rafters below the surface of the roof, although any suitable fastener can be used.

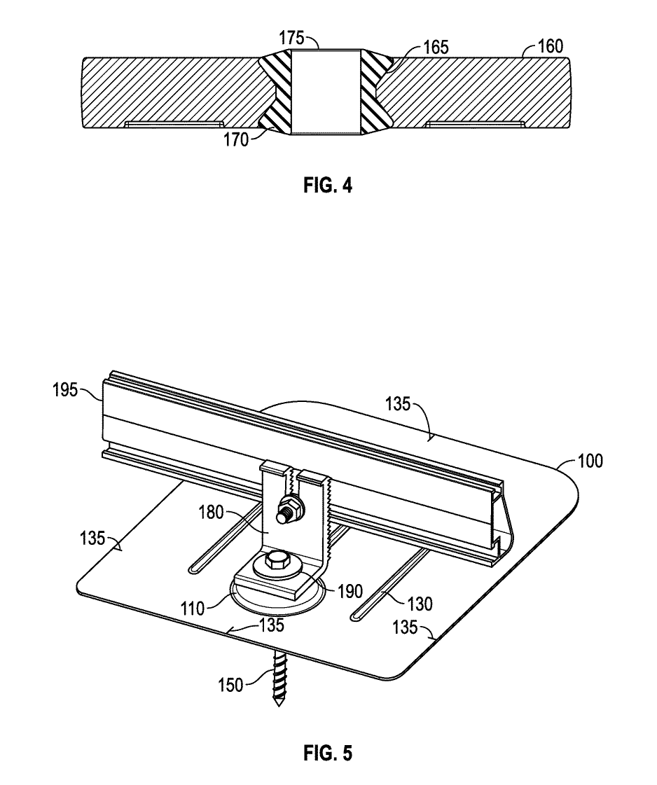

The assembly also includes a disk, also referred to as a shell, 160 with an opening 165. The opening 165 is preferably symmetrical about the center of the disk 160 and is tapered on its upper and lower surfaces. The disk 160 is preferably symmetric about its horizontal center and is preferably a solid disk made from either plastic or metal. The assembly also includes a bushing 170. The bushing 170 is preferably made of a flexible and solid material like rubber or other suitable material includes an opening 175. When the assembly is constructed, the bushing 170 is inserted into the opening 165 of disk 160 so that it fits tightly into the opening 165 as shown in FIG. 4. The height of the disk 160 can be no greater than the distance between the bottom surface of the flashing 100 and the highest point of the lower surface of the raised portion 110 of the flashing. The bushing 170 is typically in an hourglass-shape that can create a conical compression seal when assembled, but other suitable shapes may suffice if they can also provide a compression seal. The shape of the bushing 170 will depend on the contour of the opening 165 in the disk 160. When properly inserted, the upper and lower surface of the bushing 170 will conform to the contour of the inner surfaces of the opening 165 and protrude slightly above and below the opening 165 so that it forms a tight seal at the entry point of the opening 120 of the flashing to prevent liquids from entering along the perimeter of the opening 165.

The flashing assembly is typically used to support a bracket 180, which in turn is secured to a solar panel rail guide 195 (as shown in FIG. 5 and discussed further below). The bracket 180 includes an opening 185 for receiving the fastener 150. An optional washer 190 is also shown and typically rests between the top surface of the bracket 180 and the head of the fastener 150. The washer 190 is preferably made of a flexible and solid material like rubber or other suitable material and also may include a central opening, although the washer may be solid as well as long as the fastener 150 can penetrate it. When the fastener 150 is tightened, the washer 190 may provide additional protection against external liquids from entering the opening 185 on the bracket 180. The bracket 180, fastener 150, and the washer 190 are separate elements from the flashing assembly that makes up the flashing 100, bushing 170, and the disk 160.

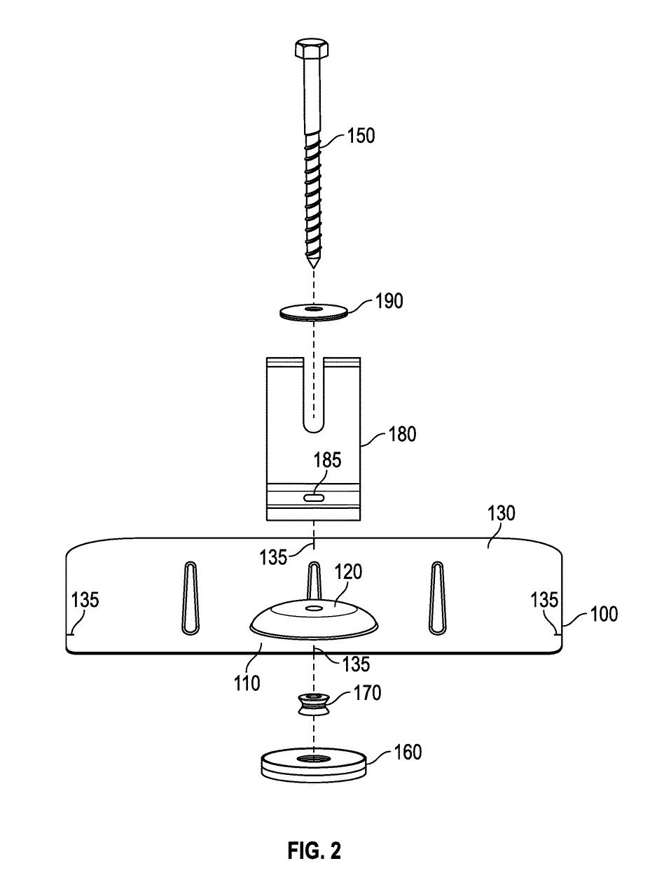

FIG. 2 shows an exploded view of the flashing assembly as shown prior to being assembled along with the bracket 180, washer 190, and fastener 150. In order for the assembly to work effectively and support the bracket 180 and rail guide 190, all of the elements shown must be axially aligned along the dashed line.

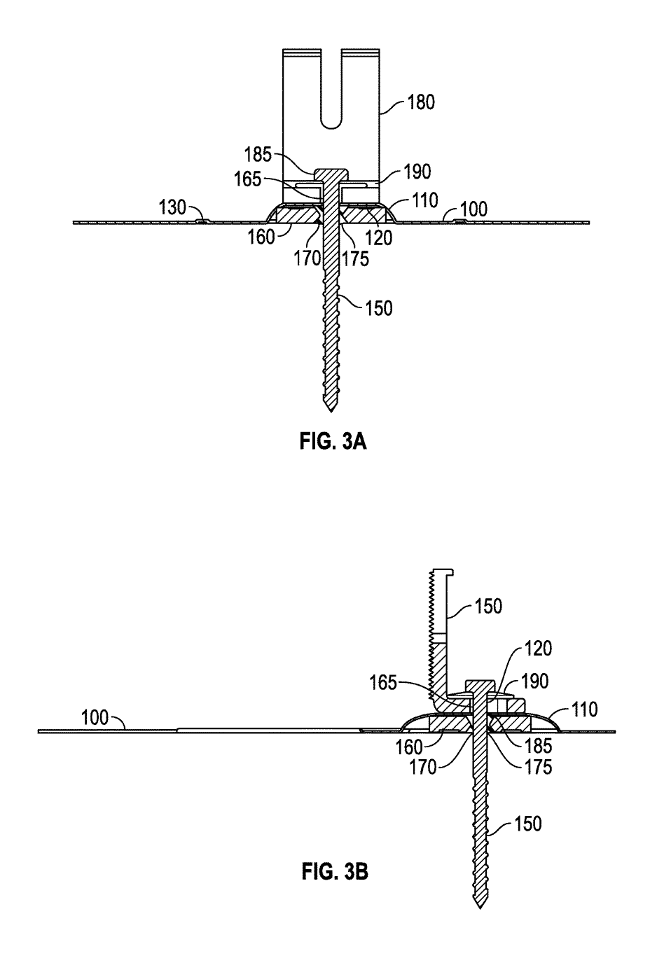

FIGS. 3A and 3B show a cross section of a front view of the assembly and a cross section of a side view of the assembly. In order to assemble the structure shown, the bushing 170 is first inserted into the disk 160 to form a water-tight seal along the contour of the disk 160 as shown in FIG. 4. The disk 160 is then inserted below the raised portion 110 such that the opening 175 in the bushing 170 is axially aligned with the opening 120 in the raised portion 110. The bracket 180 is then placed on top of the raised portion 110 so that the opening 185 of the bracket 180 is axially aligned with the opening 120 of the raised portion. The washer 190 is optionally placed on the upper surface of the bracket 180. If the washer 190 includes an opening, it is also axially aligned with the opening 185 of the bracket. The fastener 150 is then inserted through the opening of the washer 190, and through the respective openings 185, 120, and 175 until the threads of the fastener 150 penetrate the rafter of the roof. The fastener 150 is continually tightened until the downward compression force from the fastener 150 enables the washer 190 to create a water-tight seal between the head of the fastener 150 and the bracket 180, which in turn secures the bracket 180 to the raised portion 110 of the flashing. As the fastener 150 is inserted into the opening 175 of the bushing 170, the bushing 170 provides a water-tight seal around the fastener 150. The upper portion of the bushing 170 also provides a water-tight seal between the bracket 180 and the raised portion 110 of the flashing 100. The solid nature of the disk 160 acts as a bearing plate that supports the raised portion 110 of the flashing 100 from collapsing under the compression force from the fastener 150 by distributing the load across the upper portion 110.

FIG. 5 shows a completed assembly of this embodiment that includes the solar panel rail guide 195 attached to the bracket 180.

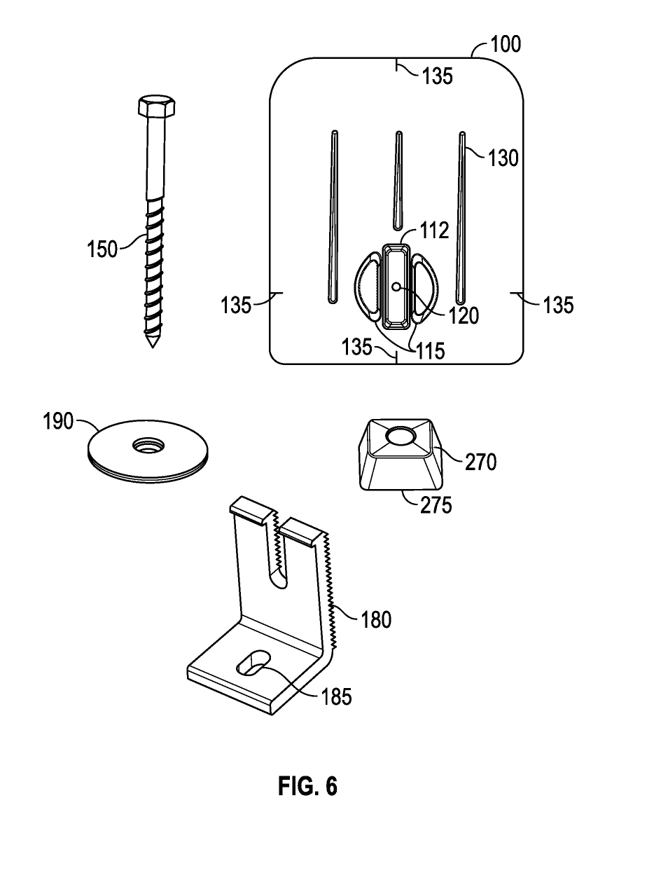

FIG. 6 illustrates another alternate embodiment of the flashing assembly described in FIGS. 1-5 above. In this embodiment, a variation of the shape of the raised portion on the flashing is provided and a bushing is utilized without a disk. The flashing assembly includes a flashing 100. The flashing 100 is generally flat and rectangular, although alternate dimensions can be used as well. The flashing 100 includes three distinct raised portions—a central raised portion 112, and two side raised portions 115. Each of the raised portions 112 and 115 are hollow inside, and include an opening 120 that is preferably located in the center of the central raised portion 112 for use in receiving a fastener 150. Each of the raised portions 112 and 115 have bases that are wider than their respective top surfaces and their respective side walls are tapered outward from top to bottom. This enables a heavy load that is placed on the top surfaces to be distributed evenly downward and prevents inward buckling of the sides of the raised portions 112 and 115 even without a bearing plate such as a disk for support. It also directs water or other liquids away from pooling around the opening 120 of the raised portion 110 and is simpler to manufacture. The flashing 100 also may include ribs 130, and alignment markings 135 on the upper surface of the flashing 100 that enable accurate installation and location of the flashing 100 on the roof. The fastener 150 shown is a wood screw that is capable of penetrating shingle roofs and securing itself to the rafters below the surface of the roof, although any suitable fastener can be used.

The assembly also includes a bushing 270. The bushing 270 is preferably made of a flexible and solid material like rubber or other suitable material includes an opening 275. The flashing assembly is typically used to support a bracket 180, which in turn is secured to a solar panel rail guide 195. The bracket 180 includes an opening 185 for receiving the fastener 150. An optional washer 190 is also shown and typically rests between the top surface of the bracket 180 and the head of the fastener 150. The washer 190 is preferably made of a flexible and solid material like rubber or other suitable material and also may include a central opening, although the washer may be solid as well as long as the fastener 150 can penetrate it. When the fastener 150 is tightened, the washer 190 may provide additional protection against external liquids from entering the opening 185 on the bracket 180. The bracket 180, fastener 150, and the washer 190 are separate elements from the flashing assembly that makes up the flashing 100 and the bushing 270.

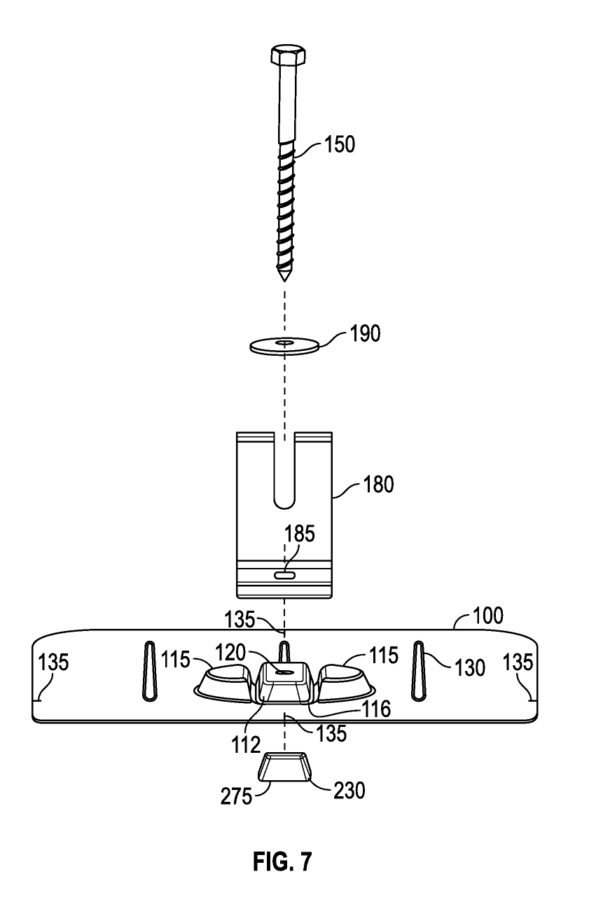

FIG. 7 shows an exploded view of the flashing assembly as shown prior to being assembled along with the bracket 180, washer 190, and fastener 150. In order for the assembly to work effectively and support the bracket 180 and rail guide 190, all of the elements shown must be axially aligned along the dashed line.

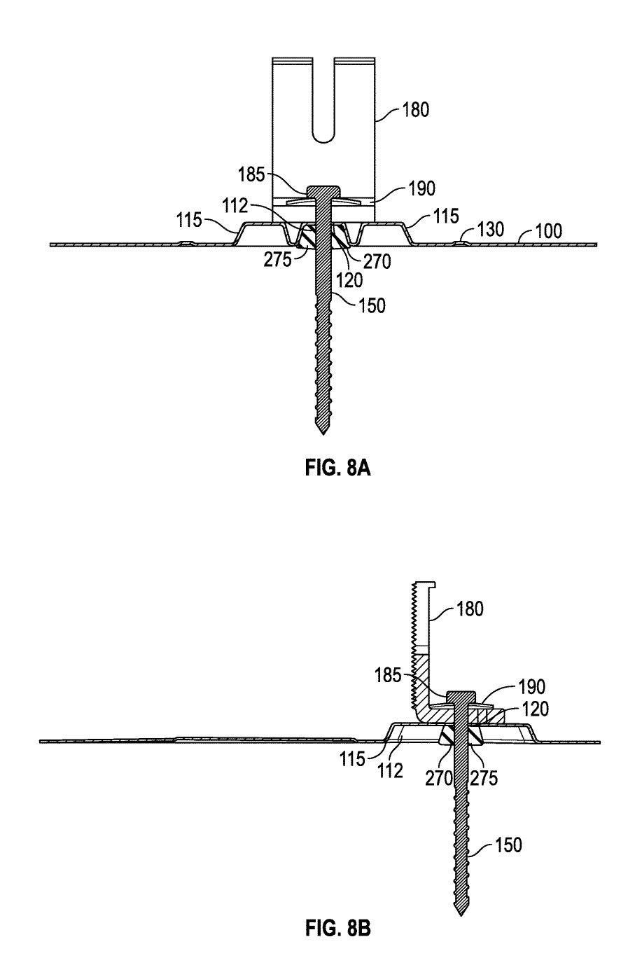

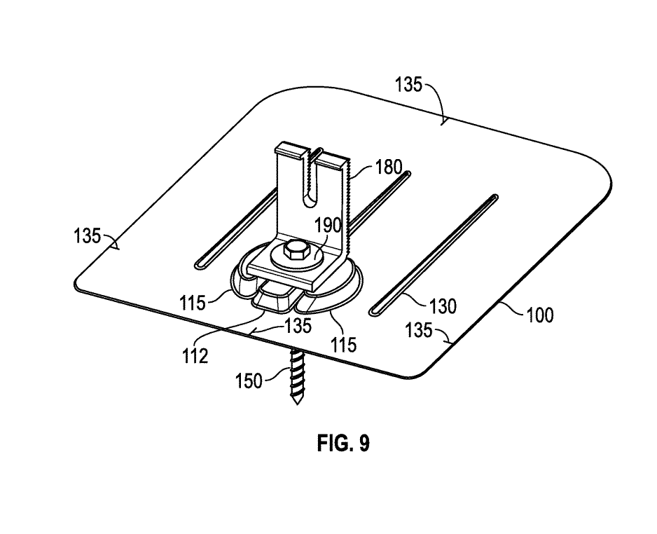

FIGS. 8A and 8B show a cross section of a front view of the assembly and a cross section of a side view of the assembly. In order to assemble the structure shown, the bushing 270 is inserted below the central raised portion 112 such that the opening 275 in the bushing 270 is axially aligned with the opening 120 in the central raised portion 112. The bracket 180 is then placed on top of all three of the raised portion 112 and 115 so that the opening 185 of the bracket 180 is axially aligned with the opening 120 of the central raised portion 112 so that the bottom of the bracket 180 covers the same amount of each of the top surfaces of the side raised portions 115. This allows even distribution of any load that is placed on top of the raised portions 112 and 115. The washer 190 is optionally placed on the upper surface of the bracket 180. If the washer 190 includes an opening, it is also axially aligned with the opening 185 of the bracket. The fastener 150 is then inserted through the opening of the washer 190, and through the respective openings 185, 120, and 275 until the threads of the fastener 150 penetrate the rafter of the roof. The fastener 150 is continually tightened until the downward compression force from the fastener 150 enables the washer 190 to create a water-tight seal between the head of the fastener 150 and the bracket 180, which in turn secures the bracket 180 to the raised portion 110 of the flashing. As the fastener 150 is inserted into the opening 275 of the bushing 270, the bushing 270 provides a water-tight seal around the fastener 150. The upper portion of the bushing 270 also provides a water-tight seal between the bracket 180 and the raised portion 110 of the flashing 100. The v-shaped walls form a space 116 between the central raised portion 112 and the side raised portions 115 create an avenue for water or other liquids to be evacuated and prevent them from collecting at the opening 120 of the central raised portion 112. Also, when the fastener 150 is tightened and creates a compressive downward force coupled with the downward force resulting from the load of the solar panel rail guide 195, the v-shaped walls also distribute the downward force evenly and prevents the raised portions 112 and 115 from collapsing downward. Finally, the v-shaped walls serve to re-shape the bushing 270 into a conical shape as shown in FIG. 8A and creates a water-tight compression seal resulting from the downward force as well. FIG. 9 shows a completed assembly of this embodiment.

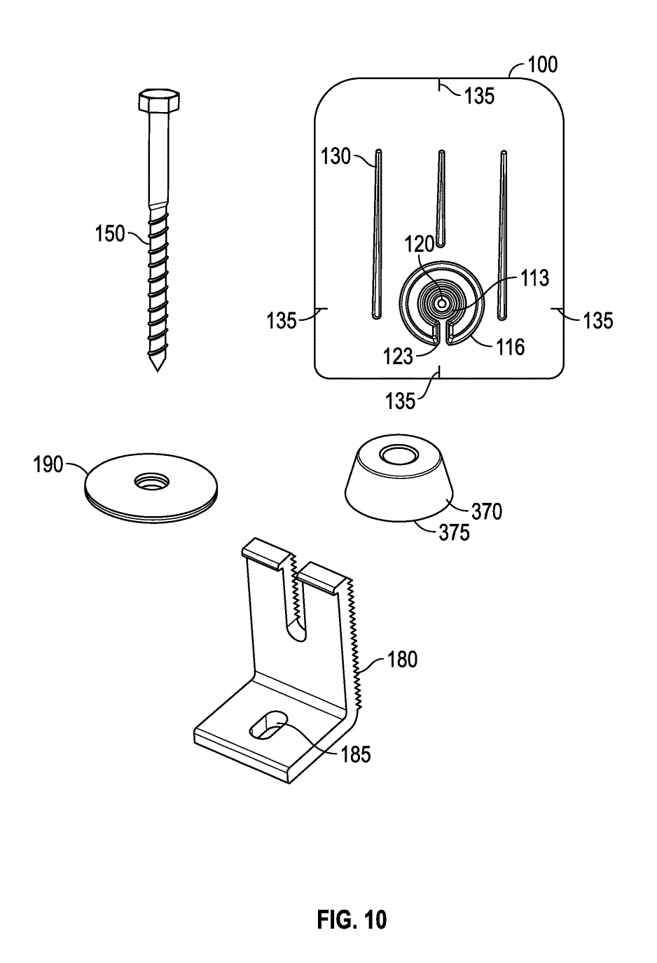

FIG. 10 illustrates another alternate embodiment of the flashing assembly described in FIGS. 1-9 above. In this embodiment, like the embodiment described in FIGS. 6-9, a variation of the shape of the raised portion on the flashing is provided and a bushing is utilized without a disk. The flashing assembly includes a flashing 100. The flashing 100 is generally flat and rectangular, although alternate dimensions can be used as well. The flashing 100 includes three distinct raised portions—a central raised portion 113, and an outer raised portion 116. The outer raised portion 116 is preferably circular in shape with an opening 123 as shown. Each of the raised portions 113 and 116 are hollow inside, and include an opening 120 that is preferably located in the center of the central raised portion 113 for use in receiving a fastener 150. Each of the raised portions 113 and 116 have bases that are wider than their respective top surfaces and their respective side walls are tapered outward from top to bottom. This enables a heavy load that is placed on the respective top surfaces to be distributed evenly downward and prevents inward buckling of the sides of the raised portions 113 and 116 even without a bearing plate such as a disk for support. It also directs water or other liquids away from pooling around the opening 120 of the raised portion 113 and is simpler to manufacture. The flashing 100 also may include ribs 130, and alignment markings 135 on the upper surface of the flashing 100 that enable accurate installation and location of the flashing 100 on the roof. The fastener 150 shown is a wood screw that is capable of penetrating shingle roofs and securing itself to the rafters below the surface of the roof, although any suitable fastener can be used.

The assembly also includes a bushing 370. The bushing 370 is preferably made of a flexible and solid material like rubber or other suitable material includes an opening 375. The bushing 370 is preferably in a conical shape that conforms to the contour of the central raised portion 113, but other suitable shapes may suffice if they can also provide a compression seal and conform to the contour of the central raised portion 113. When properly inserted beneath the central raised portion 113, the bushing 370 will conform to the contour of the inner surfaces of the central raised portion 113 so that it forms a water-tight seal at the entry point of the opening 120 of the central raised portion 113 to prevent liquids from entering along the perimeter of the opening 375. The bottom of the bushing 370 also will protrude slightly below the bottom surface of the flashing 100 to prevent liquids from entering at the bottom of the opening 375.

The flashing assembly is typically used to support a bracket 180, which in turn is secured to a solar panel rail guide 195. The bracket 180 includes an opening 185 for receiving the fastener 150. An optional washer 190 is also shown and typically rests between the top surface of the bracket 180 and the head of the fastener 150. The washer 190 is preferably made of a flexible and solid material like rubber or other suitable material and also may include a central opening, although the washer may be solid as well as long as the fastener 150 can penetrate it. When the fastener 150 is tightened, the washer 190 may provide additional protection against external liquids from entering the opening 185 on the bracket 180. The bracket 180, fastener 150, and the washer 190 are separate elements from the flashing assembly that makes up the flashing 100 and the bushing 370.

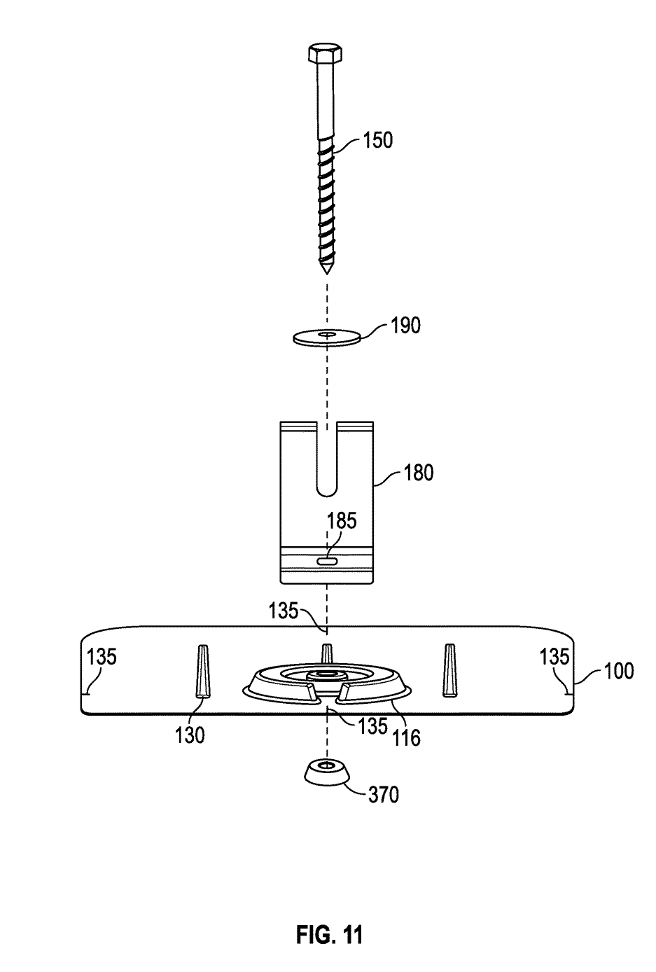

FIG. 11 shows an exploded view of the flashing assembly as shown prior to being assembled along with the bracket 180, washer 190, and fastener 150. In order for the assembly to work effectively and support the bracket 180 and rail guide 190, all of the elements shown must be axially aligned along the dashed line.

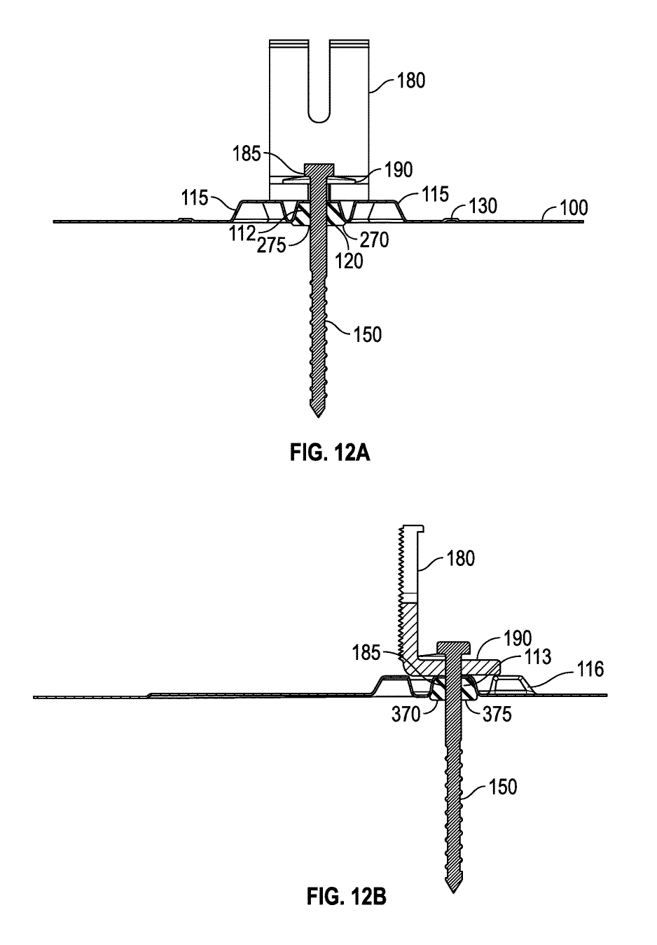

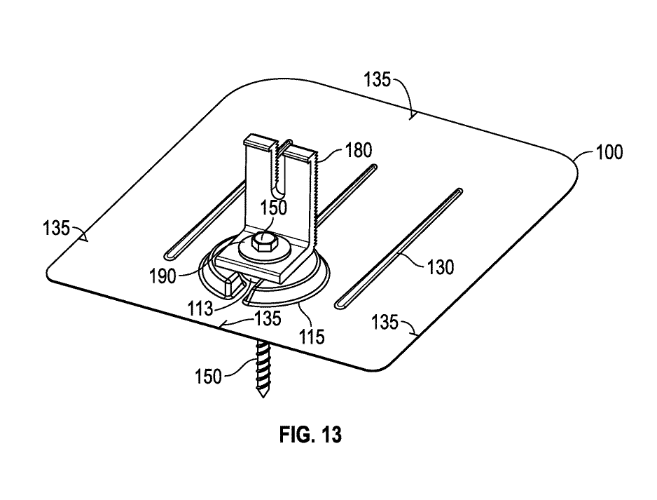

FIGS. 12A and 12B show a cross section of a front view of the assembly and a cross section of a side view of the assembly. In order to assemble the structure shown, the bushing 370 is inserted beneath the central raised portion 113 such that the opening 375 in the bushing 370 is axially aligned with the opening 120 in the central raised portion 112. The bracket 180 is then placed on top of both the central raised portion 113 and the outer raised portion 116 so that the opening 185 of the bracket 180 is axially aligned with the opening 120 of the central raised portion 113 and so that the bottom of the bracket 180 covers the same amount of each of the top surface of each side of the outer raised portion 116. This allows even distribution of any load that is placed on top of the raised portions 113 and 116. The washer 190 is optionally placed on the upper surface of the bracket 180. If the washer 190 includes an opening, it is also axially aligned with the opening 185 of the bracket. The fastener 150 is then inserted through the opening of the washer 190, and through the respective openings 185, 120, and 375 until the threads of the fastener 150 penetrate the rafter of the roof. The fastener 150 is continually tightened until the downward compression force from the fastener 150 enables the washer 190 to create a water-tight seal between the head of the fastener 150 and the bracket 180, which in turn secures the bracket 180 to the raised portion 110 of the flashing. As the fastener 150 is inserted into the opening 375 of the bushing 370, the bushing 370 provides a water-tight seal around the fastener 150. The upper portion of the bushing 370 also provides a water-tight seal between the bracket 180 and the raised portion 180 of the flashing 100. The v-shaped walls form a space 122 between the central raised portion 113 and the outer raised 116 create an avenue for water or other liquids to be evacuated and prevent them from collecting at the opening 120 of the central raised portion 113. Also, when the fastener 150 is tightened and creates a compressive downward force coupled with the downward force resulting from the load of the solar panel rail guide 195, the v-shaped walls also distribute the downward force evenly and prevents the raised portions 113 and 116 from collapsing downward. Finally, the v-shaped walls serve to create a water-tight compression seal resulting from the downward force as well. FIG. 13 shows a completed assembly of this embodiment.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An assembly for securing a solar panel array support bracket to a roof comprising:
A. a flashing further comprising a first raised portion and an opening in the raised portion;
B. a bushing further comprising an opening in the middle of the bushing wherein the entire bushing is secured within the first raised portion of the flashing:
i. such that the bushing is axially aligned with the opening in the raised portion of the flashing and enables a fastener to pass through the opening in the bushing to secure the flashing to the roof and secure the support bracket to the first raised portion of the flashing.

2. The assembly of claim 9 wherein the bushing is compressed between the first raised portion of the flashing and the surface of the roof.

3. The assembly of claim 9, wherein the bushing shape is conical.

4. The assembly of claim 9, wherein the bushing is made of rubber.

5. The assembly of claim 9, wherein the flashing further comprises a second raised portion that is adjacent to, and surrounds the perimeter of the first raised portion.

6. The assembly of claim 6, wherein a gap exists between the first raised portion and the second raised portion that enables the support bracket to be secured to the top surfaces of both the first and second raised portions.

7. The assembly of claim 7, where in the second raised portion surrounds only a portion of the perimeter of the first raised portion.

8. The assembly of claim 1, wherein the flashing further comprises a second raised portion that is adjacent and parallel to a first side of the first raised portion.

9. The assembly of claim 8, wherein the flashing further comprises a third raised portion that is adjacent and parallel to a second side of the first raised portion.

10. The assembly of claim 9, wherein a gap exists between the first raised portion and the second raised portion and a gap exists between the first raised portion and the third raised portion that enables the support bracket to be secured to the top surfaces of the first, second, and third raised portions.
